(19) United States
(12) Patent Application Publication
(10) Pub. No.: US 2025/0043695 A1
(43) Pub. Date: Feb. 6, 2025

(54) THERMALLY COMPLIANT FLANGE JOINT FOR USE WITH GAS TURBINE ENGINE COMPONENTS

(71) Applicant: Rolls-Royce North American Technologies Inc., Indianapolis, IN (US)

(72) Inventors: Kerry J. Lighty, Plainfield, IN (US); William Williamson, Indianapolis, IN (US); Michel Smallwood, Indianapolis, IN (US)

(21) Appl. No.: 18/228,258

(22) Filed: Jul. 31, 2023

(51) Int. Cl. F01D 25/12; F01D 25/24

(52) U.S. Cl. CPC F01D 25/12; F01D 25/243; F05D 2220/32; F05D 2260/20

(57) ABSTRACT

A heat-exchanger assembly includes a shroud, a heat exchanger, and a mounting system. The shroud is configured to direct a flow of air through the heat-exchanger assembly. The heat exchanger is configured to transfer heat. The mounting system is configured to couple the shroud with the heat exchanger.

### STATEMENT REGARDING FEDERALLY SPONSORED RESEARCH OR DEVELOPMENT

Embodiments of the present disclosure were made with government support under Contract No. FA8650-19-F-2078. The government may have certain rights.

### FIELD OF THE DISCLOSURE

The present disclosure relates generally to gas turbine engines, and more specifically to heat-exchanger assemblies of gas turbine engines.

### BACKGROUND

Gas turbine engines are used to power aircraft, watercraft, power generators, and the like. Gas turbine engines typically include an engine core having a compressor, a combustor, and a turbine. The compressor compresses air drawn into the engine and delivers high pressure air to the combustor. In the combustor, fuel is mixed with the high pressure air and is ignited. Products of the combustion reaction in the combustor are directed into the turbine where work is extracted to drive the compressor and, sometimes, an output shaft. Left-over products of the combustion reaction are exhausted out of the turbine and may provide thrust in some applications.

Gas turbine engines for aircraft typically include a fan and a bypass duct. The fan is driven by the turbine and pushes air through the bypass duct to create thrust for the aircraft. The bypass duct may include components configured to transfer heat between cooling fluids and the air flowing through the bypass duct. It is desirable to improve the efficiency, manufacturability, and access to such components.

### SUMMARY

The present disclosure may comprise one or more of the following features and combinations thereof.

A heat-exchanger assembly adapted for use in a gas turbine engine may comprise a shroud, a heat exchanger, and a mounting system. The shroud may be configured to direct a flow of air through the heat-exchanger assembly. The shroud may include a first side wall and a first flange. The first flange may extend outwardly away from the first side wall. The first flange may be formed to define a first mount hole that extends through the first flange. The heat exchanger may be configured to transfer heat from a cooling fluid passing through the heat exchanger to the flow of air. The heat exchanger may include a first wall and a second wall. The first wall may be engaged with the first flange of the shroud. The second wall may be spaced apart from and opposite the first wall.

In some embodiments, the mounting system may be configured to couple the shroud with the heat exchanger while allowing for movement of the shroud relative to the heat exchanger to accommodate different rates of thermal expansion experienced by the shroud and the heat exchanger during use of the heat-exchanger assembly. The mounting system may include a pin and a first bolt assembly. The pin may extend into the first flange of the shroud and the first wall of the heat exchanger to locate the shroud relative to the heat exchanger. The first bolt assembly may include a first spacer and a first bolt. The first bolt may extend along a first bolt axis through the first spacer and into the first wall of the heat exchanger to apply a compression force onto the first spacer.

In some embodiments, the first spacer may include an inner sleeve and an outer sleeve coupled with the inner sleeve. The inner sleeve may be located in the first mount hole of the first flange of the shroud such that a gap may be formed in the first mount hole between the first flange and the inner sleeve to allow the shroud and the heat exchanger to grow relative to each other. The outer sleeve may be located adjacent the first flange around at least a portion of the first mount hole such that the outer sleeve may block the shroud from moving axially relative to the first bolt axis away from the heat exchanger.

In some embodiments, the first bolt assembly of the mounting system may include a bias member. The bias member may be located between the inner sleeve and the outer sleeve of the first spacer. The bias member may urge the first flange away from the outer sleeve.

In some embodiments, the first bolt assembly of the mounting system may include a washer arranged around the inner sleeve of the first spacer. The bias member may engage the washer and the first spacer to urge the washer and the first flange away from the outer sleeve. A gap may be formed axially relative to the first bolt axis between the washer and the outer sleeve of the first spacer.

In some embodiments, the first mount hole may be substantially circular and may have a first diameter. The inner sleeve of the first spacer may be substantially circular and may have a second diameter. The second diameter of the inner sleeve of the first spacer may be less than the first diameter of the first mount hole to provide the gap formed in the first mount hole between the first flange and the inner sleeve.

In some embodiments, the first flange of the shroud may be formed to define a pin hole having a third diameter and extending through the first flange. The pin may have a fourth diameter and may extend through the pin hole into the first wall of the heat exchange. The third diameter of the pin hole may be substantially similar to the fourth diameter of the pin to block the shroud from moving relative to the heat exchanger at the pin.

In some embodiments, the shroud may include a second side wall opposite the first side wall and a second flange. The second flange may extend outwardly away from the second side wall. The second flange may be formed to define a laterally-extending hole extending through the second flange. The laterally-extending hole may have a major diameter and minor diameter that may be parallel to the second flange. The major diameter may be greater than the minor diameter. The mounting system may include a second bolt assembly. The second bolt assembly may have a second spacer and a second bolt that may extend through the second spacer, through the laterally-extending hole formed in the second flange, and into the first wall of the heat exchanger.

In some embodiments, the laterally-extending hole may be an elliptical shape. The first bolt assembly of the mounting system may include a washer arranged around the inner sleeve. A gap may be formed axially relative to the first bolt axis between the washer and the outer sleeve of the first spacer.

In some embodiments, the first flange of the shroud may be formed to define a pin hole that extends through the first flange. The pin may extend through the pin hole and into the first wall of the heat exchanger. The pin hole and the pin may have substantially similar diameters to block the shroud from moving relative to the heat exchanger at the pin.

In some embodiments, the shroud may include a second side wall and a second flange. The second side wall may be opposite the first side wall. The second flange may extend outwardly away from the second side wall. The second flange may be formed to define a laterally-extending hole extending through the second flange. The laterally-extending hole may be an elliptical shape. The mounting system may include a second bolt assembly having a second spacer and a second bolt. The second bolt may extend through the second spacer, through the laterally-extending hole formed in the second flange, and into the first wall of the heat exchanger.

According to another aspect of the present disclosure, an assembly adapted for use in a gas turbine engine may comprise of a first component, a second component, and a mounting system. The first component may include a first side wall and a first flange. The first flange may extend outwardly away from the first side wall. The first flange may be formed to define a first mount hole that extends through the first flange. The second component may include a first wall engaged with the first flange of the first component and a second wall spaced apart from and opposite the first wall.

In some embodiments, the mounting system may be configured to couple the first component with the second component while allowing for movement of the first component relative to the second component to accommodate different rates of thermal expansion experience by the first component and second component during use of the assembly. The mounting system may include a first bolt assembly having a first spacer and a first bolt. The first bolt may extend along a first bolt axis through the first spacer and into the first wall of the second component to apply a compression onto the first spacer.

In some embodiments, the first spacer may include an inner sleeve and an outer sleeve coupled with the inner sleeve. The inner sleeve may be located in the first mount hole of the first flange of the first component such that a gap is formed in the first mount hole between the first flange and the inner sleeve to allow the first component and the second component to grow relative to each other. The outer sleeve may be located adjacent the first flange around at least a portion of the first mount hole such that the outer sleeve blocks the first component from moving axially relative to the first bolt axis from the second component.

In some embodiments, the first bolt assembly of the mounting system may include a bias member located between the inner sleeve and the outer sleeve of the first spacer. The bias member may urge the first flange away from the outer sleeve and toward the first wall of the second component.

In some embodiments, the first bolt assembly of the mounting system may include a washer arranged around the inner sleeve of the first spacer. The bias member may engage the washer and the first spacer to urge the washer and the first flange away from the outer sleeve and toward the first wall of the second component.

In some embodiments, a gap may be formed axially relative to the first bolt axis between the washer and the outer sleeve of the first spacer. The first mount hole may substantially circular and may have a first diameter. The inner sleeve of the first spacer may be substantially circular and may have a second diameter. The second diameter of the inner sleeve of the first spacer may be less than the first diameter of the first mount hole to provide the gap formed in the first mount hole between the first flange and the inner sleeve.

In some embodiments, the first flange of the first component may be formed to define a pin hole that extends through the first flange and has a third diameter. The third diameter of the pin hole may be different than the first diameter of the first mount hole. The mounting system may include a pin that extends through the pin hole into the first wall of the second component.

In some embodiments, the first component may include a second side wall opposite the first side wall and a second flange. The second flange may extend outwardly away from the second side wall. The second flange may be formed to define a laterally-extending hole extending through the second flange and having a major diameter and a minor diameter that may be parallel to the second flange. The major diameter may be greater than the minor diameter. The mounting system may include a second bolt assembly having a second spacer and a second bolt. The second bolt may extend along a second bolt axis through the second spacer, through the laterally-extending hole formed in the second flange, and into the first wall of the second component.

In some embodiments, the laterally-extending hole may be an elliptical shape. The second bolt may be substantially circular. The first bolt assembly of the mounting system may include a washer arranged around the inner sleeve. A gap may be formed axially relative to the first bolt axis between the washer and the outer sleeve of the first spacer.

These and other features of the present disclosure will become more apparent from the following description of the illustrative embodiments.

### BRIEF DESCRIPTION OF THE DRAWINGS

FIG. 1 is a cutaway view of a gas turbine engine that includes an engine core having a compressor, a combustor downstream of the compressor, and a turbine downstream of the combustor, and further including a fan driven by the engine core, a bypass duct arranged around the fan and the engine core, and a heat-exchanger assembly located in the bypass duct;

FIG. 2 is a section view of a bypass duct of the gas turbine engine of FIG. 1, showing the heat-exchanger assembly is arranged in the bypass duct and includes an inlet shroud having a plurality of inlet turning vanes, a heat exchanger coupled to the inlet shroud downstream of the inlet shroud, and an outlet shroud having a plurality of outlet vanes whereby the inlet vanes and the outlet vanes help direct a flow of air through the heat exchanger while minimizing flow separation and pressure loss;

FIG. 3 is a perspective view of the inlet shroud of FIG. 2, showing the inlet shroud includes a first side wall and a first flange extending outwardly away from the first side wall for coupling with the heat exchanger, and the first flange is formed to define a first mount hole and a pin hole that both extend through the first flange;

FIG. 4 is an enlarged section view of a mounting system included in the heat-exchanger assembly of FIG. 2 showing the mounting system couples the inlet shroud with the heat exchanger and the mounting system includes a pin that extends through the pin hole formed in the first flange of the inlet shroud and into the heat exchanger and a first bolt assembly that extends through the first mount hole formed in the first flange and into the heat exchanger, the first bolt assembly including a first spacer, a first bolt extending through the first spacer, a first bias member, and a first washer;

FIG. 5 is an enlarged section view of the first bolt assembly of FIG. 4 showing the first spacer includes an inner sleeve and an outer sleeve coupled with the inner sleeve, the inner sleeve is located in the first mount hole of the first flange of the inlet shroud such that a gap is formed in the first mount hole between the first flange and the inner sleeve to allow the inlet shroud and the heat exchanger to grow relative to each other, and the outer sleeve is located adjacent the first flange around at least a portion of the first mount hole;

FIG. 6 is a top view of the heat-exchanger assembly of FIG. 2 showing the inlet shroud coupled with the heat exchanger, and further showing that the inlet shroud includes a second flange extending outwardly from a second side wall, the first flange formed to define the pin hole to receive the pin therein and the first mount hole to receive the first bolt assembly therein;

FIG. 7 is an enlarged top view of the first flange of the inlet shroud of FIG. 3 showing the first bolt assembly extending through the first mount hole and the gap formed in the first mount hole between the first flange and the inner sleeve of the first spacer of the first bolt assembly, the pin hole and the pin extending through the pin hole, and further showing the first flange is formed to define an axially-extending hole to receive a third bolt assembly therein;

FIG. 8. is an enlarged top view of the second flange of the inlet shroud of FIG. 3 showing the second flange is formed to define a laterally-extending hole extending through the second flange to receive a second bolt assembly therein and an axially-extending hole extending through the second flange to receive a fourth bolt assembly therein; and

FIG. 9 is an enlarged view of another embodiment of a first bolt assembly adapted to couple the inlet shroud with the heat exchanger, the first bolt assembly including a first bolt and a first bias member.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

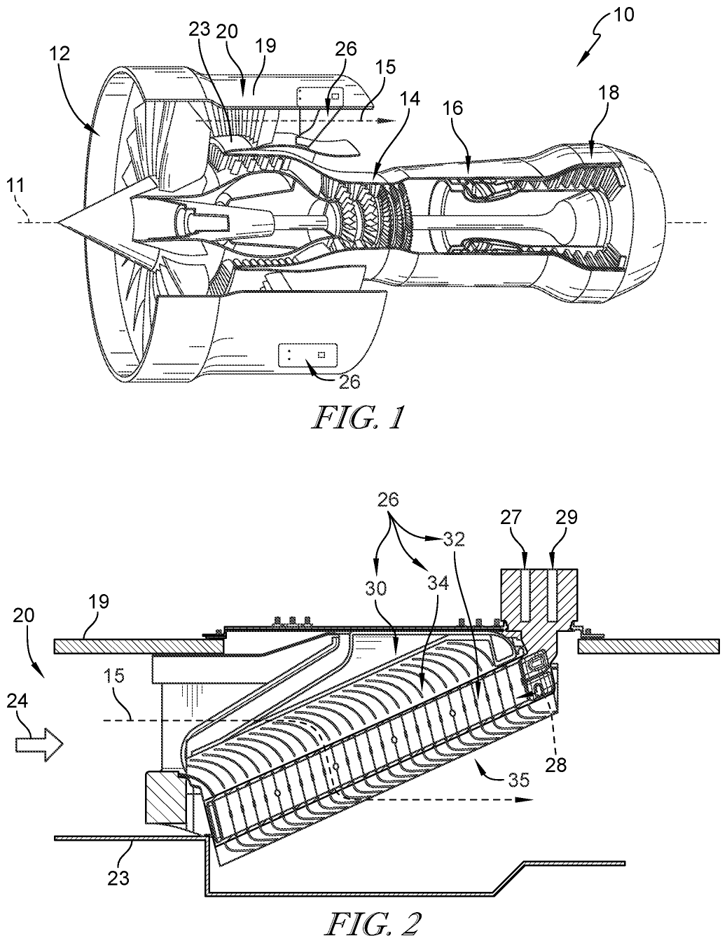

An illustrative aerospace gas turbine engine 10 includes a fan assembly 12, a compressor 14, a combustor 16 located downstream of the compressor 14, and a turbine 18 located downstream of the combustor 16 as shown in FIG. 1. The fan assembly 12 is driven by the turbine 18 and provides thrust for propelling the gas turbine engine 10 by forcing air 15 through a bypass duct 20. The compressor 14 compresses and delivers air to the combustor 16. The combustor 16 mixes fuel with the compressed air received from the compressor 14 and ignites the fuel. The hot, high-pressure products of the combustion reaction in the combustor 16 are directed into the turbine 18 to cause the turbine 18 to rotate about a central axis 11 and drive the compressor 14 and the fan assembly 12.

The fan assembly 12 rotates about the central axis 11 to force the air 15 through a flow path 24 such that the air 15 is directed through the bypass duct 20 to provide thrust to propel the gas turbine engine 10. The air 15 is ambient air and has a temperature that is less than hot, high-pressure products of the combustion reaction experienced by the combustor 16 and turbine 18. As such, a portion of the air 15 is used as a cold sink source in the present disclosure and used to cool oil, fuel, water, refrigerant, etc. for cooling the turbine 18 and/or other components such as electronics, motors, generators, etc.

The bypass duct 20 is arranged circumferentially around the central axis 11 and includes an outer wall 19 and an inner wall 23 as shown in FIG. 2. The outer wall 19 defines a radially outer boundary of the flow path 24 of the bypass duct 20. The inner wall 23 defines a radially inner boundary of the flow path 24 of the bypass duct 20.

In the illustrative embodiment, the gas turbine engine 10 further includes a heat-exchanger assembly 26 located in the bypass duct 20 as shown in FIG. 2. The air 15 flowing through the flow path 24 passes through the heat-exchanger assembly 26, and the heat-exchanger assembly 26 transfers heat from a cooling fluid 28 passing through the heat-exchanger assembly 26 to the air 15. The fluid 28 may be for example, oil, fuel, water, refrigerant, etc. The gas turbine engine 10 includes a plurality of heat-exchanger assemblies 26 spaced apart from one another circumferentially as suggested in FIG. 1. As such, each heat-exchanger assembly 26 is discrete axially and circumferentially and does not extend fully around the central axis 11. In other embodiments, the gas turbine engine 10 may include a single heat-exchanger assembly 26.

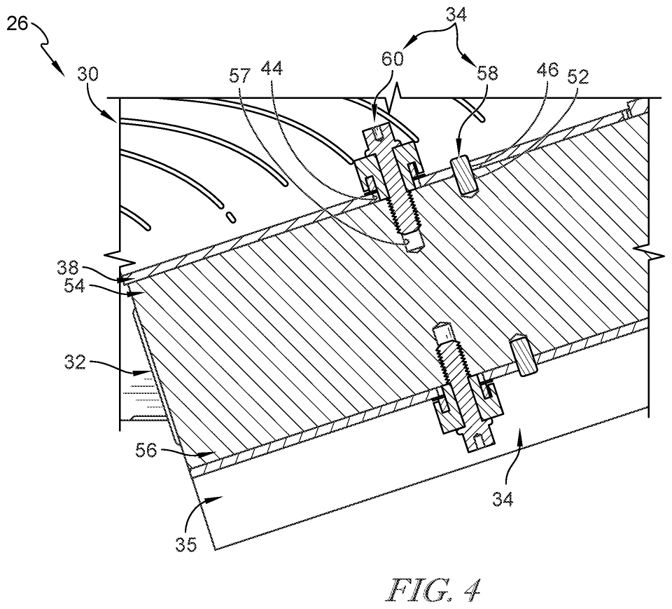

The heat-exchanger assembly 26 includes, among other things, an inlet shroud 30, a heat exchanger 32, a mounting system 34, and an outlet shroud 35 as shown in FIG. 2. The inlet shroud 30 varies a direction of the air 15 to flow into the heat exchanger 32 at a desired angle and improve uniformity of pressure and speed of the air entering the heat exchanger 32. The heat exchanger 32 is positioned downstream of the inlet shroud 30 and is configured to transfer heat from the cooling fluid 28 passing through the heat exchanger 32 to the air 15. The mounting system 34 couples the inlet shroud 30 with the heat exchanger 32. The outlet shroud 35 varies a direction of the air 15 exiting the heat exchanger 32 to redirect the air 15 primarily in the axially aft direction. A second mounting system 34 couples the outlet shroud 35 with the heat exchanger 32 as shown in FIG. 4.

Components of the gas turbine engine 10, such as the inlet shroud 30 and the heat exchanger 32, experience different rates of thermal expansion. The inlet shroud 30 and the heat exchanger 32 may be made of different materials that have different rates of thermal expansion. For example, the fluid 28 flowing through the heat exchanger 32 may be a different temperature than the air 15 flowing through the inlet shroud 30. The temperature difference of the fluid 28 and the air 15, along with the different materials of the inlet shroud 30 and the heat exchanger 32, may result in the inlet shroud 30 and the heat exchanger 32 thermally expanding at different rates, which may cause thermal strain for the inlet shroud 30 and the heat exchanger 32 as the inlet shroud 30 and the heat exchanger 32 are mounted to each other. The outlet shroud 35 may experience the same thermal growth difference compared with the heat exchanger 32. Moreover, other components in the gas turbine engine 10 experience differences in thermal growth.

The present disclosure provides the mounting system 34 to couple the inlet shroud 30 with the heat exchanger 32, while allowing for movement of the inlet shroud 30 relative to the heat exchanger 32 to accommodate different rates of thermal expansion experienced by the inlet shroud 30 and the heat exchanger 32. The mounting system 34 also provides frictional damping between the inlet shroud 30 and the heat exchanger 32. A second mounting system 34 is used to couple the outlet shroud 35 with the heat exchanger 32 as shown in FIG. 4. Additionally, the mounting system 34 may be used to couple together any other suitable components of the gas turbine engine 10. For simplicity, the mounting system 34 is described and shown only in use with the inlet shroud 30 and the heat exchanger 32.

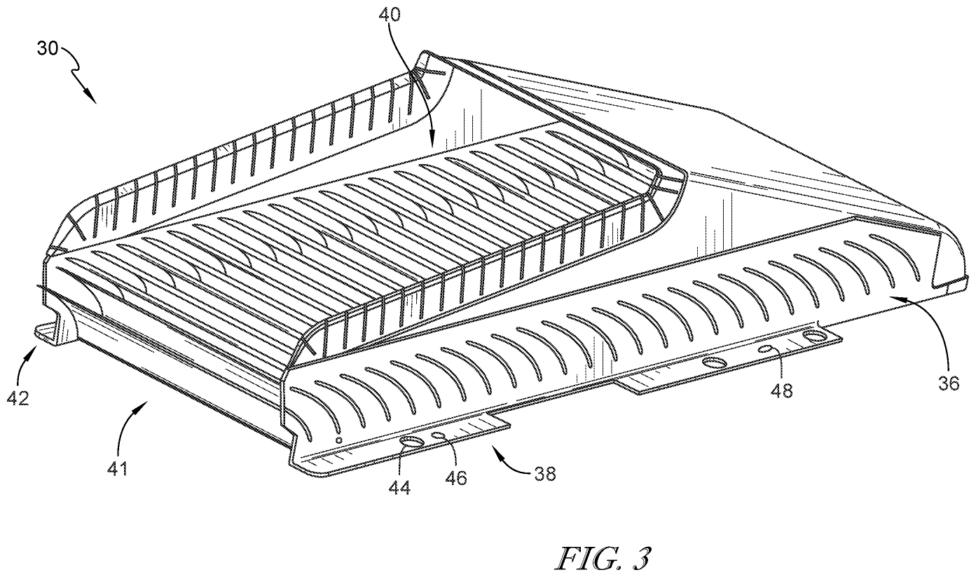

The inlet shroud 30 includes a first side wall 36 and a first flange 38 that extends outwardly away from the first side wall 36 as shown in FIG. 3. In the illustrative embodiment, the first side wall 36 and the first flange 38 are substantially perpendicular to each other. In illustrative embodiments, the first flange 38 includes a front flange portion and an aft flange portion. In some embodiments, the first flange 38 is formed as a single component extending outwardly away from the first side wall 36.

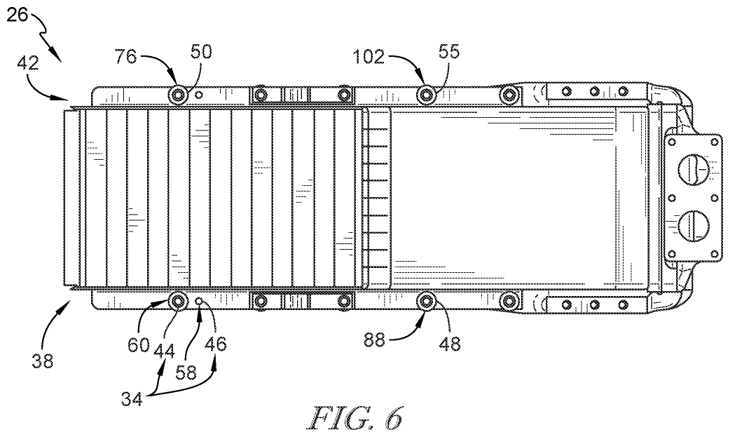

The inlet shroud 30 further includes a second side wall 40 opposite the first side wall 36 and a second flange 42 that extends outwardly away from the second side wall 40 as shown in FIGS. 3 and 6. The second side wall 40 is in parallel spaced apart relation to the first side wall 36. In the illustrative embodiment, the second side wall 40 and the second flange 42 are substantially perpendicular to one another. In illustrative embodiments, the second flange 42 includes a front flange portion and an aft flange portion. In some embodiments, the second flange 42 is formed as a single component extending outwardly away from the second side wall 40.

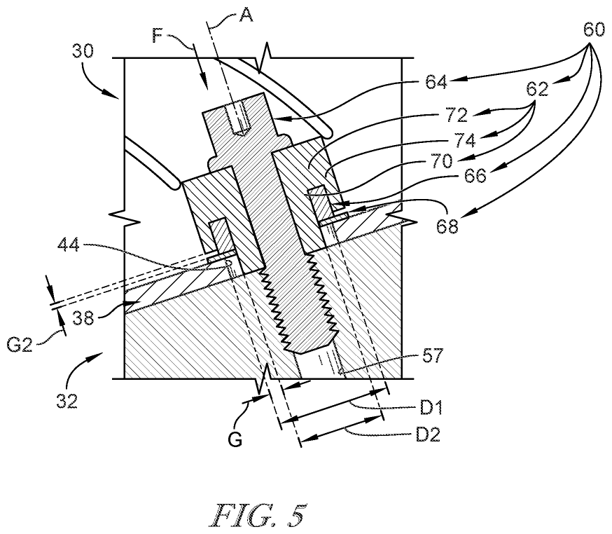

The first flange 38 of the inlet shroud 30 is formed to define a first mount hole 44 that extends through the first flange 38 as shown in FIG. 3. In the illustrative embodiment, the first mount hole 44 is substantially circular and has a first diameter D1 as shown in FIG. 5.

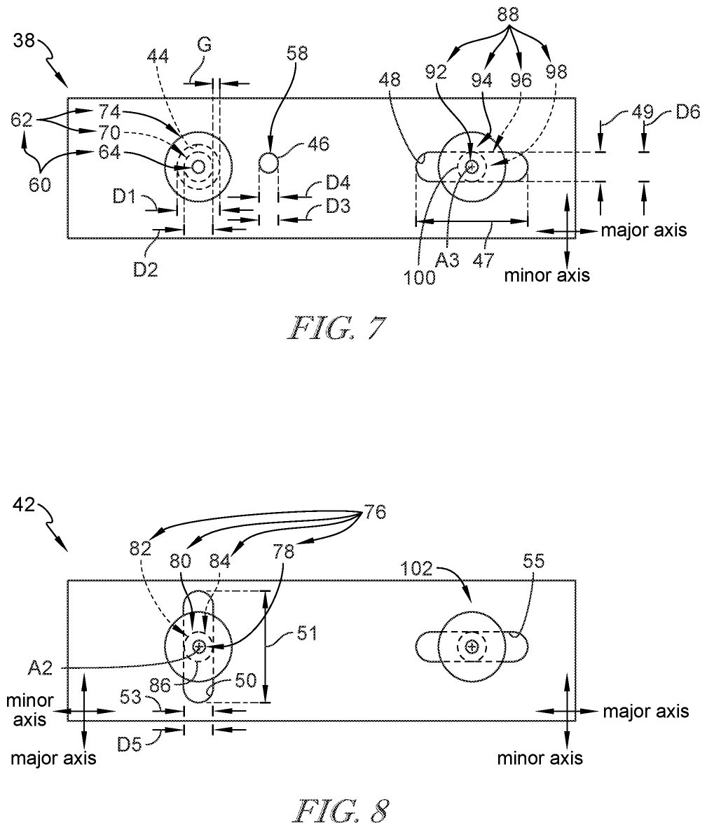

The first flange 38 is further formed to define a pin hole 46 that extends through the first flange 38 as shown in FIG. 3. The pin hole has a third diameter D3 as shown in FIG. 7. In the illustrative embodiment, the third diameter D3 is less than the first diameter D1.

The inlet shroud 30 further includes a plurality of inlet turning vanes 41 as shown in FIG. 3. The plurality of inlet turning vanes 41 are located between the first side wall 36 and the second side wall 40 and are configured to adjust a direction of the air 15 entering the heat exchanger 32. The plurality of inlet turning vanes 41 turn the portion of air 15 by adjusting a direction of the flow of the air 15 such that the air 15 enters the heat exchanger 32 in a direction normal to the first wall 54 of the heat exchanger 32 in the illustrative embodiment. The outlet shroud 35 includes similar components and has first and second side walls, flanges, and a plurality of outlet turning vanes.

The heat exchanger 32 includes a first wall 54 and a second wall 56 as shown in FIG. 4. The second wall 56 is spaced apart from and opposite the first wall 54 to locate cooling passages therebetween. The first wall 54 is coupled to the first flange 38 and the second flange 42 of the inlet shroud 30. The second wall 56 is coupled with the outlet shroud 35. The heat exchanger 32 includes a flow path located between the first wall 54 and the second wall 56. In the illustrative embodiment, the fluid 28 flows into an inlet 27 through the outer wall 19, into the flow path axially forward, turns and returns axially aft to an outlet 29 through the outer wall 19. In other embodiments, alternative inlet, outlet, and flow paths may be used.

The first wall 54 of the heat exchanger 32 is formed to include a pin-receiving hole 52 and mount-receiving hole 57 as shown in FIG. 4. In some embodiments, the first wall 54 is formed to include additional pin-receiving holes 52 and additional mount-receiving holes 57.

The heat exchanger 32 extends at an angle relative to the central axis 11 as shown in FIG. 2. The heat exchanger 32 extends radially inward and axially forward from the outer wall 19. Illustratively, the heat exchanger 32 extends radially entirely between the outer wall 19 and the inner wall 23 such that the bypass duct 20 is blocked radially by the heat exchanger 32, though it will be understood the another portion of the air 15 not flowing through the heat-exchanger assembly 26 flows around sides of heat-exchanger assembly 26.

The mounting system 34 is configured to couple the inlet shroud 30 with the heat exchanger 32 as shown in FIGS. 4-6. The mounting system 34 allows for movement of the inlet shroud 30 relative to the heat exchanger 32 to accommodate different rates of thermal expansion experienced by the inlet shroud 30 and the heat exchanger 32 during use of the heat-exchanger assembly 26.

The mounting system 34 includes a pin 58 and a first bolt assembly 60 as shown in FIGS. 4-7. The pin 58 extends through the pin hole 46 formed in the first flange 38 and into the pin-receiving hole 52 formed in the first wall 54 of the heat exchanger 32. The first bolt assembly 60 extends through the first mount hole 44 formed in the first flange 38 and into the mount-receiving hole 57 formed in the first wall 54 of the heat exchanger 32.

The pin 58 locates the inlet shroud 30 relative to the heat exchanger 32 as suggested in FIGS. 4 and 7. The pin 58 has a fourth diameter D4. The fourth diameter D4 of the pin 58 is substantially similar to the third diameter D3 of the pin hole 46 so that the inlet shroud 30 is blocked from moving relative to the heat exchanger 32 at the fixed location of the pin 58. The pin 58 provides a datum location from which the inlet shroud 30 and the heat exchanger 32 may thermally grow from relative to each other. In some embodiments, the mounting system 34 includes additional pins 58 and additional pin holes 46 formed in the first flange 38 and/or the second flange 42 of the inlet shroud 30.

The first bolt assembly 60 includes a first bolt 64, a first spacer 62, a first bias member 66, and a first washer 68 as shown in FIG. 5. The first bolt 64 extends through the first spacer 62, the first bias member 66, and the first washer 68. The first bolt assembly 60 allows the inlet shroud 30 to grow and translate in a plane relative to the heat exchanger 32.

The first bolt 64 extends along a first bolt axis A through the first spacer 62, the first mount hole 44 formed in the first flange 38 of the inlet shroud 30, and into the mount-receiving hole 57 formed in the first wall 54 of the heat exchanger 32. The first bolt 64 applies a compression force F onto the first spacer 62 which transmits the compression force F to the heat exchanger 32 as suggested in FIG. 5. In some embodiments, the first bolt 64 includes external threads that engage internal threads formed in the mount-receiving hole 57 of the first wall 54 of the heat exchanger 32.

The first spacer 62 includes an inner sleeve 70, a connection member 72, and an outer sleeve 74 as shown in FIG. 5. The connection member 72 extends between and couples the inner sleeve 70 with the outer sleeve 74. The inner sleeve 70 is located in the first mount hole 44 of the first flange 38 of the inlet shroud 30. The outer sleeve 74 is located adjacent the first flange 38 around at least a portion of the first mount hole 44. The inner sleeve 70, the connection member 72, and the outer sleeve 74 are integrally formed as a single, one-piece component in the illustrative embodiment.

The inner sleeve 70 of the first spacer 62 is substantially circular and has a second diameter D2 as shown in FIG. 5. The second diameter D2 of the inner sleeve 70 is less than the first diameter D1 of the first mount hole 44 that the inner sleeve 70 is located in. Due to the difference in diameters D1, D2 of the inner sleeve 70 and the first mount hole 44, a gap G is formed in the first mount hole 44 between the first flange 38 and the inner sleeve 70. The inner sleeve 70 transmits the compression force F directly to the heat exchanger 32 in the illustrative embodiment. As a result, the first bolt 64, the first spacer 62, and the heat exchanger 32 are rigidly connected.

The gap G allows the inlet shroud 30 and the heat exchanger 32 to grow relative to each other as the inlet shroud 30 and the heat exchanger 32 experience different rates of thermal growth. The inlet shroud 30 can move radially relative to the first bolt axis A because of the gap G. Thus, the inlet shroud 30 can slide and/or shift, once friction has been overcome, relative to the heat exchanger 32 as the inner sleeve 70 of the first spacer 62 and the first bolt 64 shift within the first mount hole 44 to make use of the gap G in response to thermal growth of the components.

The outer sleeve 74 is located adjacent the first flange 38 around at least a portion of the first mount hole 44 as shown in FIG. 5. In the illustrative embodiment, the outer sleeve 74 is not located within the first mount hole 44. Because the outer sleeve 74 is located adjacent the first flange 38 and exterior to the first mount hole 44, the outer sleeve 74 blocks the first flange 38, and thus the inlet shroud 30, from moving axially relative to the first bolt axis A away from the heat exchanger 32.

The first bias member 66 is located between the inner sleeve 70 and the outer sleeve 74 of the first spacer 62 as shown in FIG. 5. The first bias member 66 urges the first flange 38 of the inlet shroud 30 away from the outer sleeve 74 of the first spacer 62 so that the first washer 68 remains engaged with the first flange 38 and the first flange 38 remains engaged with the first wall 54 of the heat exchanger 32. Thus, the first bias member 66 urges the first flange 38 into contact with the first wall 54 of the heat exchanger 32. Relative to the first bolt axis A, the first bias member 66 is located radially between the inner sleeve 70 and the outer sleeve 74 of the first spacer 62 and is located axially between the connection member 72 of the first spacer 62 and the first washer 68.

The first bias member 66 provides a second compression force onto the inlet shroud 30 that is less than the compression force F. The second compression force keeps the inlet shroud 30 coupled with the heat exchanger 32 while allowing the inlet shroud 30 freedom to expand and contract due to thermal growth relative to the heat exchanger 32. The first bias member 66 may be selected to provide a predetermined force based on the compression force F, for example. The outer sleeve 74 may be spaced apart from the inlet shroud 30 by a predetermined amount, but provides a physical block to limit and stop radial movement of the inlet shroud 30 relative to the axis A. In the illustrative embodiment, the first bias member 66 is a compression spring. In alternative embodiments, the first bias member 66 is any other suitable mechanism to urge the first flange 38 away from the outer sleeve 74 and toward the first wall 54 of the heat exchanger 32.

The first washer 68 of the first bolt assembly 60 is arranged around the inner sleeve 70 of the first spacer 62 as shown in FIG. 5. The first bias member 66 engages the first washer 68 to urge the first washer 68 and first flange 38 away from the outer sleeve 74 and toward the first wall 54 of the heat exchanger 32.

A gap G2 is formed axially relative to the first bolt axis A between the first washer 68 and the outer sleeve 74 of the first spacer 62 as shown in FIG. 5. The gap G2 allows the first washer 68 and the first flange 38, and thus the inlet shroud 30, to move axially relative to the first bolt axis A away from the first wall 54 of the heat exchanger 32 as the inlet shroud 30 and the heat exchanger 32 thermally grow and shrink. The first washer 68 and the first flange 38 can shift axially away from the first wall 54 of the heat exchanger 32 until the first washer 68 contacts the outer sleeve 74. The outer sleeve 74 blocks additional axial movement of the inlet shroud 30 away from the heat exchanger 32.

Turning back to the inlet shroud 30, in some embodiments, the second flange 42 of the inlet shroud 30 is formed to define a laterally-extending hole 50 extending through the second flange 42 as shown in FIGS. 6 and 8. The laterally-extending hole 50 is shaped as an elliptical having a major axis and a minor axis as compared to the circular first mount hole 44. Along the major axis, the laterally-extending hole 50 has a major diameter 51. Along the minor axis, the laterally-extending hole 50 has a minor diameter 53. The minor axis of the laterally-extending hole 50 is parallel to the first flange 38 and the second flange 42. The major diameter 51 of the laterally-extending hole 50 is greater than the minor diameter 53 of the laterally-extending hole 50. The laterally-extending hole 50 allows for growth in a single lateral axis (radial growth is still allowed and limited) as compared to the planar movement allowed by first mount hole 44.

In some embodiments, the mounting system 34 further includes a second bolt assembly 76 as shown in FIG. 6. The second bolt assembly 76 includes a second bolt 78, a second spacer 80, a second bias member 82, and a second washer 84. The second bolt 78 extends through the second spacer 80, the second bias member 82, and the second washer 84. The second bolt 78 extends along a second bolt axis A2. The second bolt assembly 76 is substantially similar to the first bolt assembly 60 such that the description regarding the first bolt assembly 60 applies to the second bolt assembly 76 unless contradictory to the description of the second bolt assembly 76.

In the illustrative embodiment, the second bolt 78 extends through the second spacer 80, the laterally-extending hole 50 formed in the second flange 42 of the inlet shroud 30, and into the first wall 54 of the heat exchanger 32 as shown in FIG. 6. An inner sleeve 86 of the second spacer 80 has a fifth diameter D5 that is substantially equivalent to the minor diameter 53 of the laterally-extending hole 50. The fifth diameter D5 of the inner sleeve 86 is less than the major diameter 51 of the laterally-extending hole 50, thereby allowing the second flange 42, and thus the inlet shroud 30, to slide and/or shift radially relative to the second bolt axis A2 along the major axis of the laterally-extending hole 50 at the second bolt assembly 76 once friction has been overcome.

Because the fifth diameter D5 of the inner sleeve 86 of the second spacer 80 is substantially equivalent to the minor diameter 53 of the laterally-extending hole 50, the second flange 42, and thus the inlet shroud 30, is blocked from sliding and/or shifting relative to the second bolt axis A2 along the minor axis of the laterally-extending hole 50 at the second bolt assembly 76. Thus, the laterally-extending hole 50 and the second bolt assembly 76 allow for movement of the inlet shroud 30 in a direction along the major axis of the laterally-extending hole 50, while blocking movement the inlet shroud 30 in a direction along the minor axis of the laterally-extending hole 50 at the second bolt assembly 76.

Turning back to the inlet shroud 30, in some embodiments, the first flange 38 is further formed to define an axially-extending hole 48 as shown in FIG. 7. The axially-extending hole 48 is shaped as an elliptical having a major axis and a minor axis. Along the major axis, the axially-extending hole 48 has a major diameter 47. The major axis of the axially-extending hole 48 is parallel to the first flange 38 and the second flange 42. Along the minor axis, the axially-extending hole 48 has a minor diameter 49. The major diameter 47 of the axially-extending hole 48 is greater than the minor diameter 49 of the axially-extending hole 48.

In some embodiments, the mounting system 34 further includes a third bolt assembly 88 that extends through the axially-extending hole 48 formed in the first flange 38 as shown in FIGS. 6 and 7. The third bolt assembly 88 is substantially similar to the first bolt assembly 60 and the second bolt assembly 76 such that the description regarding the first bolt assembly 60 applies to the third bolt assembly 88 unless contradictory to the description of the third bolt assembly 88.

The third bolt assembly 88 includes a third bolt 92, a third spacer 94, a third bias member 96, and a third washer 98 as shown in FIG. 7. The third bolt 92 extends through the third spacer 94, the third bias member 96, and the third washer 98. The third bolt 92 extends along a third bolt axis A3.

In the illustrative embodiment, the third bolt 92 extends through the third spacer 94, the axially-extending hole 48 formed in the first flange 38 of the inlet shroud 30, and into the first wall 54 of the heat exchanger 32 as shown in FIG. 6. An inner sleeve 100 of the third spacer 94 has a sixth diameter D6 that is substantially equivalent to the minor diameter 49 of the axially-extending hole 48. The sixth diameter D6 of the inner sleeve 100 is less than the major diameter 47 of the axially-extending hole 48, which allows the first flange 38, and thus the inlet shroud 30, to slide and/or shift radially relative to the third bolt axis A3 along the major axis of the axially-extending hole 48 at the third bolt assembly 88 once friction has been overcome.

Because the inner sleeve 100 of the third spacer 94 has the sixth diameter D6 that is substantially equivalent to the minor diameter 49 of the axially-extending hole 48, the first flange 38, and thus the inlet shroud 30, is blocked from sliding and/or shifting radially relative to the third bolt axis A3 along the minor axis of the axially-extending hole 48 at the third bolt assembly 88. Thus, the axially-extending hole 48 and the third bolt assembly 88 allow for movement of the inlet shroud 30 in a direction along the major axis of the axially-extending hole 48, while blocking movement of the inlet shroud 30 along the minor axis of the axially-extending hole 48.

Turning back to the inlet shroud 30, in some embodiments, the second flange 42 of the inlet shroud 30 is further formed to define an axially-extending hole 55 substantially similar to the axially-extending hole 48 formed in the first flange 38.

In some embodiments, the mounting system 34 further includes a fourth bolt assembly 102 that extends through the axially-extending hole 55 formed in the second flange 42 as shown in FIGS. 6 and 8. The fourth bolt assembly 102 is substantially similar to the first bolt assembly 60 and the third bolt assembly 88 such that the description regarding the first bolt assembly 60 applies to the fourth bolt assembly 102 unless contradictory to the description of the fourth bolt assembly 102.

Much like the axially-extending hole 48 and the third bolt assembly 88, the axially-extending hole 55 and the fourth bolt assembly 102 allow for movement of the inlet shroud 30 in a direction along the major axis of the axially-extending hole 55, while blocking movement of the inlet shroud 30 along the minor axis of the axially-extending hole 55.

In some embodiments, the mounting system 34 includes additional bolt assemblies 60, 76, 88, 102 and additional mount holes 44, additional axially-extending holes 48, 55, and/or additional laterally-extending holes 50 formed in the first flange 38 and/or the second flange 42 of the inlet shroud 30.

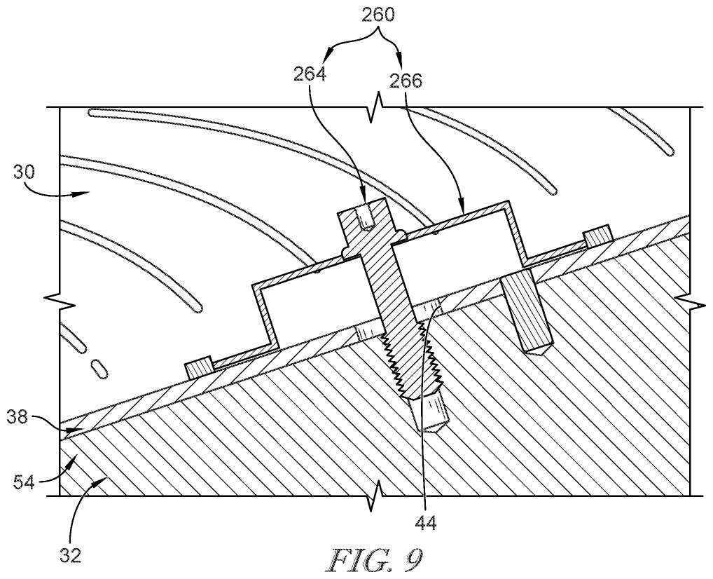

Another embodiment of a first bolt assembly 260 in accordance with the present disclosure is shown in FIG. 9. The first bolt assembly is similar to the first bolt assembly 60 shown in FIGS. 4-7 and described herein. Accordingly, similar reference numbers in the 200 series indicate features that are common between the first bolt assembly 60 and the first bolt assembly 260. The description of the first bolt assembly 60 is incorporated by reference to apply to the first bolt assembly 260, expect in instances when it conflicts with the specific description and the drawings of the first bolt assembly 260.

The first bolt assembly 260 includes a first bolt 264 and a first bias member 266 as shown in FIG. 9. The first bolt 264 extends through the first mount hole 44 formed in the first flange 38 and into the first wall 54 of the heat exchanger 32. The first bolt 264 extends through the first bias member 266. Due to the difference in diameters of the first bolt 264 and the first mount hole 44, a gap is formed in the first mount hole 44 between the first flange 38 and the first bolt 264. The gap allows the inlet shroud 30 and the heat exchanger 32 to grow relative to each other as the inlet shroud 30 and the heat exchanger 32 experience different rates of thermal growth. The inlet shroud 30 can slide and/or shift relative to the heat exchanger 32, once friction has been overcome, as the first bolt 264 shifts within the first mount hole 44 to make use of the gap in response to thermal growth of the components.

The first bias member 266 transmits a compression force to the first flange 38 in the illustrative embodiment. The compression force keeps the inlet shroud 30 coupled with the heat exchanger 32 while allowing the inlet shroud 30 freedom to expand and contract due to thermal growth relative to the heat exchanger 32. The first bias member 266 may be selected to provide a predetermined force. In one embodiment, the first bias member 266 is a Belleville washer or a Belleville spring. In another embodiment, the first bias member 266 is a spring bar.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

1. A heat-exchanger assembly adapted for use in a gas turbine engine, the heat-exchanger assembly comprising:
a shroud configured to direct a flow of air through the heat-exchanger assembly, the shroud including a first side wall and a first flange that extends outwardly away from the first side wall, the first flange formed to define a first mount hole that extends through the first flange and a pin hole that extends through the first flange axially spaced apart from the first mount hole, the first mount hole being substantially circular and having a first diameter and the pin hole having a second diameter that is less than the first diameter,
a heat exchanger configured to transfer heat from a cooling fluid passing through the heat exchanger to the flow of air, the heat exchanger including a first wall engaged with the first flange of the shroud and a second wall spaced apart from and opposite the first wall, and
a mounting system configured to couple the shroud with the heat exchanger while allowing for movement of the shroud relative to the heat exchanger to accommodate different rates of thermal expansion experienced by the shroud and the heat exchanger during use of the heat-exchanger assembly, the mounting system including a pin and a first bolt assembly, the pin extends through the pin hole formed in the first flange of the shroud and into the first wall of the heat exchanger to locate the shroud relative to the heat exchanger, the pin having a third diameter that is substantially similar to the second diameter of the pin hole, the first bolt assembly includes a first spacer and a first bolt that extends along a first bolt axis through the first spacer and into the first wall of the heat exchanger to apply a compression force onto the first spacer,
wherein the first spacer includes an inner sleeve and an outer sleeve coupled with the inner sleeve, the inner sleeve is located in the first mount hole of the first flange of the shroud and has a fourth diameter that is less than the first diameter of the first mount hole such that a gap is formed in the first mount hole between the first flange and the inner sleeve to allow the shroud and the heat exchanger to grow relative to each other, and the outer sleeve is located adjacent the first flange around at least a portion of the first mount hole such that the outer sleeve blocks the shroud from moving axially relative to the first bolt axis away from the heat exchanger.

2. The heat-exchanger assembly of claim 1, wherein the first bolt assembly of the mounting system includes a bias member located between the inner sleeve and the outer sleeve of the first spacer and the bias member urges the first flange away from the outer sleeve.

3. The heat-exchanger assembly of claim 2, wherein the first bolt assembly of the mounting system includes a washer arranged around the inner sleeve of the first spacer and the bias member engages the washer and the first spacer to urge the washer and the first flange away from the outer sleeve.

4. The heat-exchanger assembly of claim 3, wherein a gap is formed axially relative to the first bolt axis between the washer and the outer sleeve of the first spacer.

5-6. (canceled)

7. The heat-exchanger assembly of claim 1, wherein the shroud includes a second side wall opposite the first side wall and a second flange that extends outwardly away from the second side wall, the second flange is formed to define a laterally-extending hole extending through the second flange and having a major diameter and a minor diameter that is parallel to the second flange, the major diameter being greater than the minor diameter, and the mounting system including a second bolt assembly having a second spacer and a second bolt that extends through the second spacer, through the laterally-extending hole formed in the second flange, and into the first wall of the heat exchanger.

8. The heat-exchanger assembly of claim 7, wherein the laterally-extending hole is an elliptical shape.

9. The heat-exchanger assembly of claim 1, wherein the first bolt assembly of the mounting system includes a washer arranged around the inner sleeve and a gap is formed axially relative to the first bolt axis between the washer and the outer sleeve of the first spacer.

10-11. (canceled)

12. An assembly adapted for use in a gas turbine engine, the assembly comprising:
a first component including a first side wall, a second side wall spaced apart from the first side wall, a first flange that extends outwardly away from the first side wall in a first direction, and a second flange that extends outwardly away from the second side wall in a second direction opposite the first direction, the first flange formed to define a first mount hole that extends through the first flange and a pin hole that extends through the first flange axially aft of the first mount hole, the first mount hole being substantially circular and having a first diameter and the pin hole having a second diameter that is less than the first diameter, the second flange formed to define a laterally-extending hole extending through the second flange and having a major diameter and a minor diameter that is parallel to the second flange, the major diameter being greater than the minor diameter,
a second component including a first wall engaged with the first flange and the second flange of the first component and a second wall spaced apart from and opposite the first wall, and
a mounting system configured to couple the first component with the second component while allowing for movement of the first component relative to the second component to accommodate different rates of thermal expansion experienced by the first component and the second component during use of the assembly, the mounting system including a first bolt assembly having a first spacer and a first bolt that extends along a first bolt axis through the first spacer, through the first mount hole, and into the first wall of the second component to apply a compression force onto the first spacer, a second bolt assembly having a second spacer and a second bolt that extends along a second bolt axis through the second spacer, through the laterally-extending hole, and into the first wall of the second component to apply a compression force onto the second spacer, and a pin that extends through the pin hole into the first wall of the second component, the pin having a third diameter that is substantially similar to the second diameter of the pin hole,
wherein the first spacer includes an inner sleeve and an outer sleeve coupled with the inner sleeve, the inner sleeve is located in the first mount hole of the first flange of the first component such that a gap is formed in the first mount hole between the first flange and the inner sleeve to allow the first component and the second component to grow relative to each other, and the outer sleeve is located adjacent the first flange around at least a portion of the first mount hole such that the outer sleeve blocks the first component from moving axially relative to the first bolt axis away from the second component.

13. The assembly of claim 12, wherein the first bolt assembly of the mounting system includes a bias member located between the inner sleeve and the outer sleeve of the first spacer and the bias member urges the first flange away from the outer sleeve and toward the first wall of the second component.

14. The assembly of claim 13, wherein the first bolt assembly of the mounting system includes a washer arranged around the inner sleeve of the first spacer and the bias member engages the washer and the first spacer to urge the washer and first flange away from the outer sleeve and toward the first wall of the second component.

15. The assembly of claim 14, wherein a gap is formed axially relative to the first bolt axis between the washer and the outer sleeve of the first spacer.

16. The assembly of claim 12, wherein the inner sleeve of the first spacer is substantially circular and has a fourth diameter, and the fourth diameter of the inner sleeve of the first spacer is less than the first diameter of the first mount hole to provide the gap formed in the first mount hole between the first flange and the inner sleeve.

17. (canceled)

18. The assembly of claim 12, wherein the laterally-extending hole is a first laterally-extending hole, the first flange is formed to define a second laterally-extending hole extending through the first flange and having a major diameter that is parallel to the first flange and a minor diameter, the major diameter being greater than the minor diameter, and the mounting system including a third bolt assembly having a third spacer and a third bolt that extends along a third bolt axis through the third spacer, through the second laterally-extending hole formed in the first flange, and into the first wall of the second component.

19. The assembly of claim 18, wherein the first laterally-extending hole is an elliptical shape and the second bolt is substantially circular, and wherein the second laterally-extending hole is an elliptical shape and the third bolt is substantially circular.

20. (canceled)

21. The heat-exchanger assembly of claim 7, wherein the second side wall of the shroud is spaced apart from the first side wall of the shroud, the first flange of the shroud extends outwardly away from the first side wall in a first direction and the second flange of the shroud extends outwardly away from the second side wall in a second direction opposite the first direction such that the first side wall and the second side wall are located between the first flange and the second flange.

22. The heat-exchanger assembly of claim 21, wherein the first flange includes a first front flange portion and a first aft flange portion spaced apart from and axially aft of the first front flange portion, and wherein the second flange includes a second front flange portion and a second aft flange portion spaced apart from and axially aft of the second front flange portion.

23. The heat-exchanger assembly of claim 7, wherein the laterally-extending hole is a first laterally-extending hole, and wherein the first flange is formed to define a second laterally-extending hole extending through the first flange and having a major diameter that is parallel to the first flange and a minor diameter, the major diameter being greater than the minor diameter, and the mounting system including a third bolt assembly having a third spacer and a third bolt that extends through the third spacer, through the second laterally-extending hole formed in the first flange, and into the first wall of the heat exchanger

24. The heat-exchanger assembly of claim 23, wherein the second flange is formed to define a third laterally-extending hole extending through the second flange and having a major diameter that is parallel to the second flange and a minor diameter, the major diameter being greater than the minor diameter, and the mounting system including a fourth bolt assembly having a fourth spacer and a fourth bolt that extends through the fourth spacer, through the third laterally-extending hole formed in the second flange, and into the first wall of the heat exchanger.

25. The heat-exchanger assembly of claim 24, wherein the pin hole is located axially between the first mount hole and the second laterally-extending hole, and wherein the first laterally-extending hole is located axially forward of the third laterally-extending hole.

26. The assembly of claim 18, wherein the pin hole is located axially between the first mount hole and the second laterally-extending hole.
